(19) United States
(12) Patent Application Publication
(10) Pub. No.: US 2016/0379776 A1
(43) Pub. Date: Dec. 29, 2016

(54) KEYBOARD FOR AN ELECTRONIC DEVICE

(71) Applicant: Intel Corporation, Santa Clara, CA (US)

(72) Inventor: Nicholas W. Oakley, Portland, OR (US)

(73) Assignee: Intel Corporation, Santa Clara, CA (US)

(21) Appl. No.: 14/752,922

(22) Filed: Jun. 27, 2015

(51) Int. Cl. H01H 13/84

(52) U.S. Cl. CPC H01H 13/84; H01H 2215/03; H01H 2215/044; H01H 2215/028

(57) ABSTRACT

Particular embodiments described herein provide for a system that includes means for receiving a signal from a key, the signal indicating that the key has been activated and means for sending lateral haptic feedback to the key in response to the received signal that the key was activated. Additionally, the system may include a means for generating acoustic feedback in response to the received signal indicating that the key was activated and a means for generating visual feedback in response to the received signal indicating that the key was activated.

### TECHNICAL FIELD

Embodiments described herein generally relate to a keyboard for an electronic device.

### BACKGROUND

End users have more electronic device choices than ever before. A number of prominent technological trends are currently afoot (e.g., more computing devices, thinner lighter devices, etc.), and these trends are changing the electronic device landscape. One of the technological trends is a growing demand for extremely light and thin keyboards to reduce the bulk and weight of electronic devices. Virtual keyboards (or typing on glass) are often ergonomically uncomfortable and typically do not provide an enjoyable user experience. Keyboards for convertible laptops and peripheral keyboards are often thick and cumbersome for carrying from place to place. As conventional key heights are lowered to provide thinner keyboards, the key travel becomes an issue and thin keyboards often fail to offer an acceptable user experience. Currently, keyboard designs often stifle the user's flexibility, along with hindering the overall consumer experience of the associated electronic device. Hence, there is a challenge in providing a thin lightweight keyboard that can provide a traditional keyboard typing experience.

### BRIEF DESCRIPTION OF THE DRAWINGS

Embodiments are illustrated by way of example and not by way of limitation in the FIGURES of the accompanying drawings, in which like references indicate similar elements and in which:

FIG. 1A is a simplified orthographic view illustrating an embodiment of an electronic device in a closed clamshell configuration, in accordance with one embodiment of the present disclosure;

FIG. 1B is a simplified schematic diagram illustrating a side view of an electronic device in an open clamshell configuration, in accordance with one embodiment of the present disclosure;

FIG. 1C is a schematic diagram illustrating a side view of an electronic device in an open clamshell configuration, in accordance with one embodiment of the present disclosure;

FIG. 2 is a simplified schematic diagram illustrating a side view of a portion of an electronic device in an open clamshell configuration, in accordance with one embodiment of the present disclosure;

FIG. 3 is a simplified schematic diagram illustrating a side view of a portion of an electronic device in an open clamshell configuration, in accordance with one embodiment of the present disclosure;

FIG. 4 is a simplified cutaway side view illustrating an embodiment of a portion of a keyboard of an electronic device in accordance with one embodiment of the present disclosure;

FIG. 5 is a simplified cutaway side view illustrating an embodiment of a portion of a keyboard of an electronic device in accordance with one embodiment of the present disclosure;

FIG. 6 is a simplified cutaway side view illustrating an embodiment of a portion of a keyboard of an electronic device in accordance with one embodiment of the present disclosure;

FIG. 7 is a simplified pan view illustrating an embodiment of a portion of a keyboard of an electronic device in accordance with one embodiment of the present disclosure;

FIG. 8 is a simplified block diagram illustrating an embodiment of a portion of a keyboard of an electronic device in accordance with one embodiment of the present disclosure;

FIG. 9 is a simplified schematic diagram illustrating a side view of an electronic device in an open clamshell configuration, in accordance with one embodiment of the present disclosure;

FIG. 10 is a simplified block diagram associated with an example ARM ecosystem system on chip (SOC) of the present disclosure; and

FIG. 11 is a simplified block diagram illustrating example logic that may be used to execute activities associated with the present disclosure.

The FIGURES of the drawings are not necessarily drawn to scale, as their dimensions can be varied considerably without departing from the scope of the present disclosure.

### DETAILED DESCRIPTION OF EXAMPLE EMBODIMENTS

### Example Embodiments

The following detailed description sets forth example embodiments of apparatuses, methods, and systems relating to detachable unit configurations for an electronic device. Features such as structure(s), function(s), and/or characteristic(s), for example, are described with reference to one embodiment as a matter of convenience; various embodiments may be implemented with any suitable one or more of the described features.

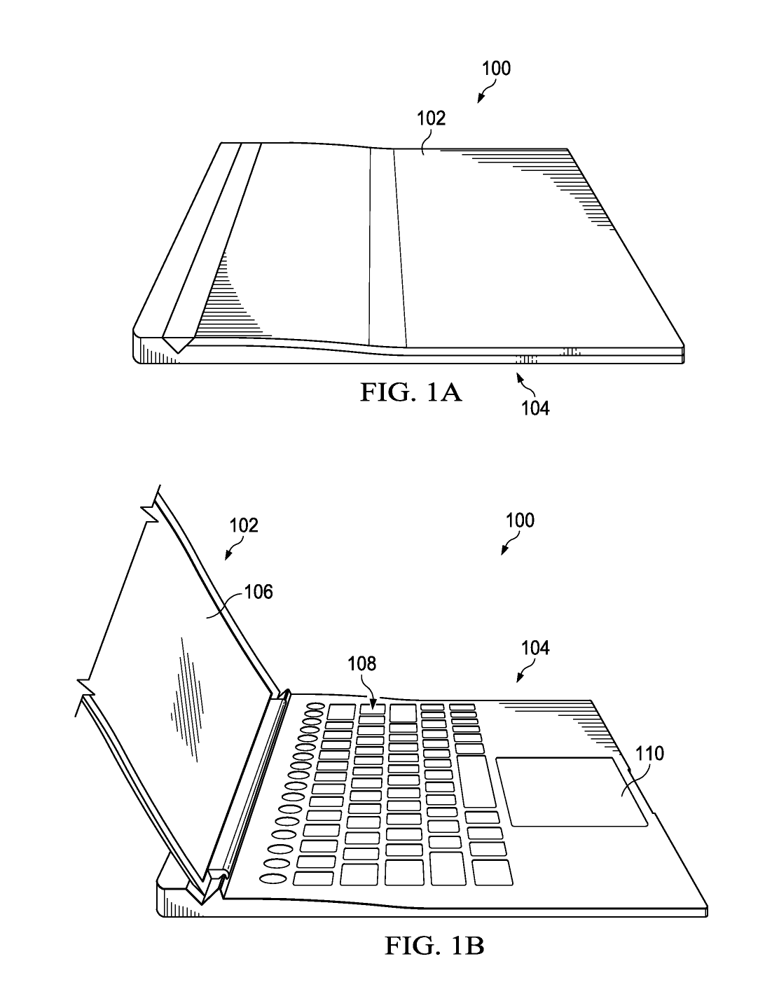

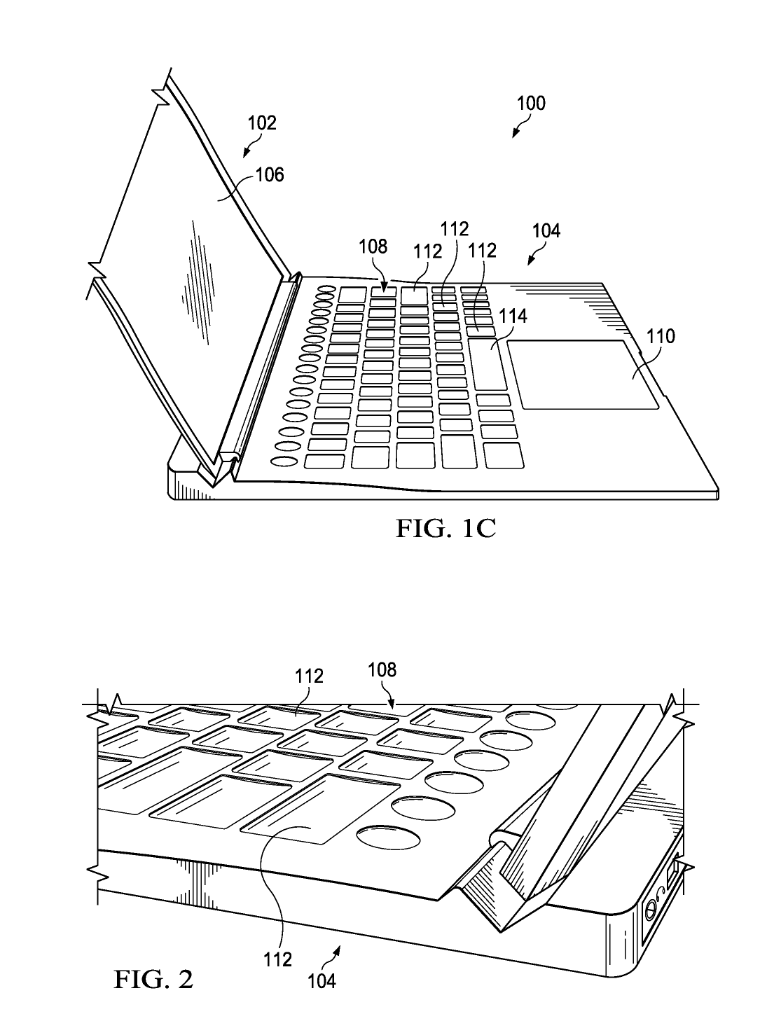

FIG. 1A is a simplified orthographic view illustrating an embodiment of an electronic device 100 in a closed clamshell configuration in accordance with one embodiment. Electronic device 100 may include a first housing 102 and a second housing 104. In one or more embodiments, electronic device 100 is a notebook computer or laptop computer. In still other embodiments, electronic device 100 may be any suitable electronic device having a keyboard such as a personal computer, mobile device, a tablet computer and/or a tablet device phablet, a personal digital assistant (PDA), an audio system, a movie player of any type, a computer docking station, etc. In the particular embodiment shown in FIG. 1, electronic device 10 is a relatively thin and sleek clamshell computer

Turning to FIG. 1B, FIG. 1B is a side view illustrating an embodiment of an electronic device 100 in an open clamshell configuration in accordance with one embodiment of the present disclosure. Electronic device 100 may include first housing 102 and second housing 104. First housing 102 can included a display 106. Second housing 104 can include keyboard portion 108 and a touchpad 110. Display 106 can be a liquid crystal display (LCD) display screen, a light-emitting diode (LED) display screen, an organic light-emitting diode (OLED) display screen, a plasma display screen, or any other suitable display screen system. In an embodiment, electronic device 100 may contain a camera, a microphone, and speakers.

Turning to FIG. 1C, FIG. 1C is a side view illustrating an embodiment of an electronic device 100 in an open clamshell configuration in accordance with one embodiment of the present disclosure. Keyboard portion 108 may include a plurality of keys 112 and a space bar 114. In an embodiment, first housing 102 can be configured as a standalone tablet and second housing 104 can be configured as a peripheral keyboard. In an embodiment, keys 112 are digital or electronic keys that are non-mechanical that do not travel like conventional keys on a keyboard. For example, keys 112 may be configured as keys or keyboard by wire where keys 112 are touch sensitive and input is through touch rather than displacement sensitive where the input is through displacement of keys 112.

In general terms, electronic device 100 can include a means for receiving a signal from a key indicating that the key has been activated and a means for sending a lateral haptic feedback to the key in response to the received signal. The system may also include a means for generating acoustic feedback in response to the received signal and a means for generating visual feedback in response to the received signal. In an example, the haptic, acoustic, and visual feedback can be adjusted using a user interface. In another example, the keys can be configured as a shallow depression in a surface of electronic device 100.

For purposes of illustrating certain example features of electronic devices 100, the following foundational information may be viewed as a basis from which the present disclosure may be properly explained. The push to reduce thickness in clamshell notebooks requires individually addressing chassis wall thicknesses, the thickness of display panels, battery, motherboard component height, and I/O. One of the least negotiable components is the keyboard whose, “z” dimensions are driven by optimal key travel and associated mechanical parts, typically resulting in a keyboard thickness of around 3.5 mm. There is a growing demand for extremely light and thin keyboards to reduce the bulk and weight of delivering a good touch typing experience. However, traditionally, thin keyboard configurations fail to offer an acceptable user experience. Virtual keyboards that require typing on glass (or some other material) are often ergonomically uncomfortable. Furthermore, peripheral keyboards (e.g., Bluetooth keyboards) are often thick and cumbersome for carrying from place to place. Currently, keyboard designs often stifle a user's flexibility, along with hindering the overall consumer experience of the associated electronic device. In addition, current thin keyboard configurations typically do not have individual key haptic effects for a physical keyboard. One current solution is to use a scissor mechanism along with a collapsible rubber dome. The key drawback of this approach is z-height limitations of the collapsible rubber dome which cannot allow for zero (or very low) key travel.

An electronic device that includes a keyboard design with haptic effects, as outlined in FIG. 1, can resolve these issues (and others). In electronic device 100 of FIG. 1, a typing experience can be delivered that's better than a touch-screen experience by using one or more of the topography of key depressions, haptic impulse, and acoustic and visual feedback. For example, second housing 104 can be configured to deliver a “keyboard-by-wire” experience where the mechanical feedback is simulated using haptic feedback, acoustic cues, visual cues, or any combination thereof. In an example, the feedback and cues can be customizable by a user in a control panel that would allow adjustment of multiple variables including haptic, acoustic, and backlight output. In addition, second housing 104 can offer resistance to dust ingress. Further, because they keys (e.g., keys 112) essentially present a relatively large touch area, electronic device 100 can be configured to deliver sweep or stroke gestural interaction across multiple keys.

In operation, the spacing between keys 112 can enable a touch-typer to distinguish between the keys using their fingers. Edge keys can be specially designed for thinner sides. An edge key configuration allows keys to hang over the edge of the keyboard to accommodate the thinner sides of the keyboard portion. Second housing 104 can include any suitable dimensions, sizes, and shapes: all of which are encompassed by the present disclosure.

Note that any number of connectors (e.g., Universal Serial Bus (USB) connectors (e.g., in compliance with the USB 3.0 Specification), Thunderbolt™ connectors, WiFi connectors, a non-standard connection point such as a docking connector, etc.) and a plurality of antennas can be provisioned in conjunction with electronic device 100. [Thunderbolt™ and the Thunderbolt logo are trademarks of Intel Corporation in the U.S. and/or other countries.] The antennas are reflective of electrical components that can convert electric currents into radio waves. In particular examples, the antennas can be associated with WiFi activities, wireless connections more generally, small cell deployments, Bluetooth, 802.11, etc.

In regards to the internal structure associated with electronic device 100, each of first housing 102 and second housing 104 can include memory elements for storing information to be used in the operations outlined herein. Each of first housing 102 and second housing 104 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in electronic device 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, first housing 102 and second housing 104 may include software modules to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of first housing 102 and second housing 104 may include a processor that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

Electronic device 100 can be an electronic element and includes, for example, desktop computers, laptop computers, mobile devices, personal digital assistants, smartphones, tablets, or other similar devices. Second housing 104 may be secondary hardware such as a peripheral that is in communication with first housing 102. The term “peripheral” as used herein, is generally defined as any auxiliary device such as a keyboard that connects to and works with an electrical device such as a computer in some way.

Turning to FIG. 2, FIG. 2 is a simplified schematic diagram illustrating a side view of a portion of an electronic device in an open clamshell configuration, in accordance with one embodiment of the present disclosure. As illustrated in FIG. 2, each key 112 may be configured as a shallow depression in the surface of second housing 104. This configuration can create a better feel of the keys for the user.

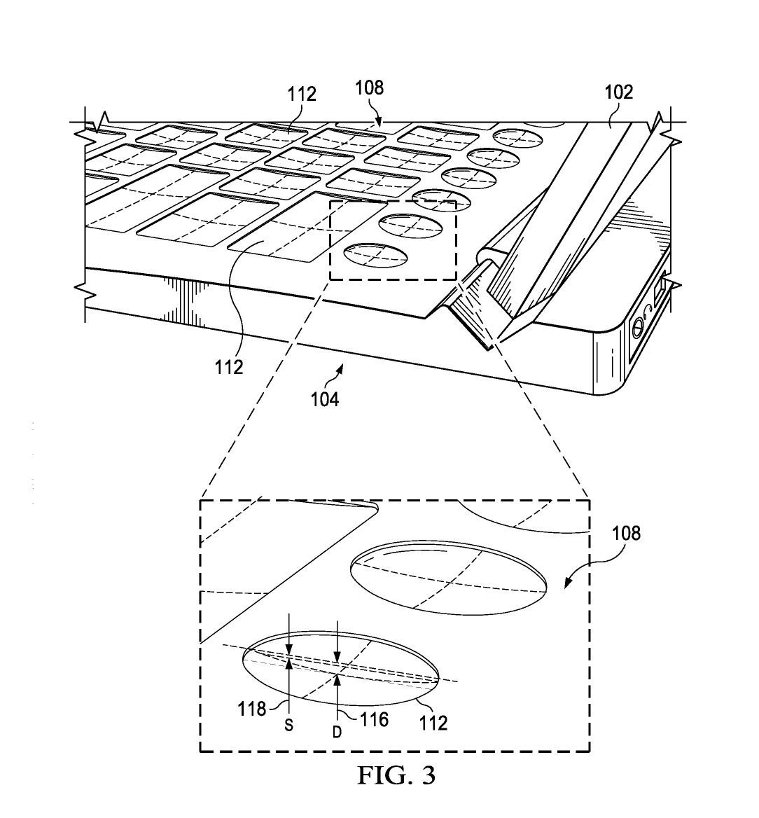

Turning to FIG. 3, FIG. 3 is a simplified schematic diagram illustrating a side view of a portion of an electronic device in an open clamshell configuration, in accordance with one embodiment of the present disclosure. As illustrated in FIG. 3, each key 112 may have a center depth 116 and a side depth 118. In an example, center depth 116 is greater than side depth 118 and creates a slope to the relative center of key 112 to allow each key to have a shallow depression. In a specific example, a center depth 116 of 0.8 mm and a side depth 118 of 0.3 mm was found to allow for an easily achieved touch-typing finger location experience.

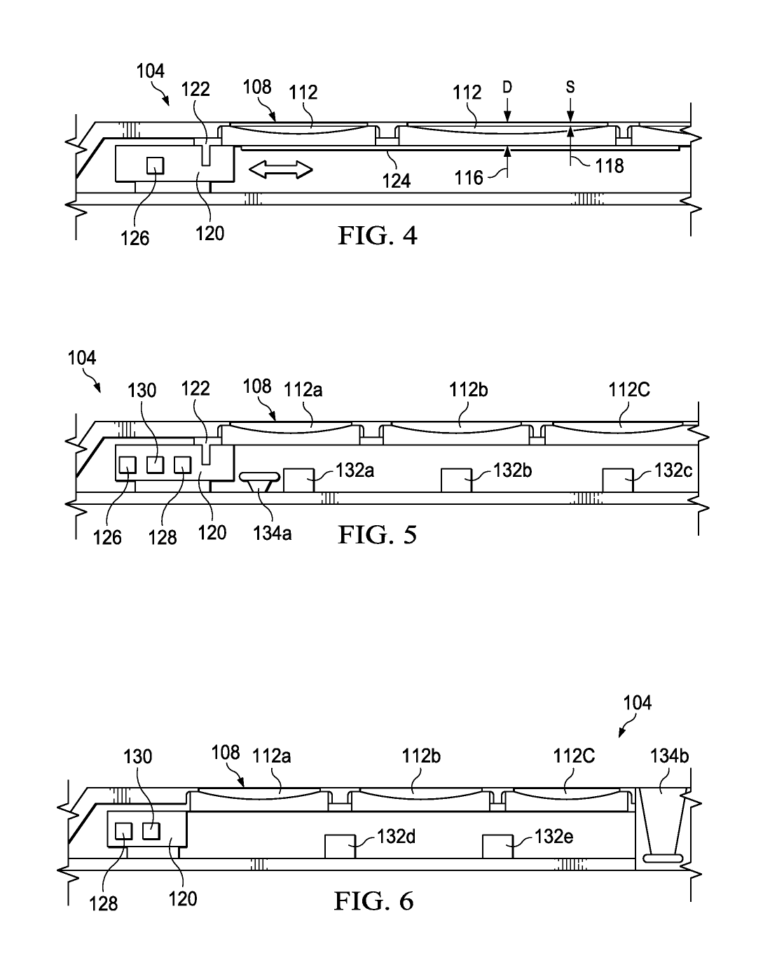

Turning to FIG. 4, FIG. 4 is a simplified cutaway side view illustrating an embodiment of a portion of an electronic device in accordance with one embodiment of the present disclosure. Second housing 104 can include keyboard 108, a key feedback module 120, and touch sensitive layer 124. Keyboard 108 can include keys 112. Key feedback module 120 can include a haptic actuator 122 and a haptic module 126.

Keys 112 and touch sensitive layer 124 can be interconnected and configured to response to haptic impulses from haptic actuator 122. For example, when a specific key 112 is touched by a user, haptic module 126 can sense the user's touch and provide lateral haptic feedback using haptic actuator 122. The lateral haptic feedback can be perceived by the user to simulate mechanical characteristics of a keyboard.

Turning to FIG. 5, FIG. 5 is a simplified cutaway side view illustrating an embodiment of a portion of an electronic device in accordance with one embodiment of the present disclosure. Second housing 104 can include keyboard 108, key feedback module 120, a plurality of illumination sources 132a-132c, and a speaker 134a. Keyboard 108 can include a plurality of keys 112a-112c. Key feedback module 120 can include haptic actuator 122, haptic module 126, an illumination module 128, and a sound module 130. Each illumination source 132a-132c can correspond to a specific key 112a-112c. For example, illumination source 132a corresponds to key 112a, illumination source 132b corresponds to key 112b, and illumination source 132c corresponds to key 112c.

When a specific key (e.g., key 112a) is touched by a user, haptic module 126 can sense the user's touch and provide lateral haptic feedback using haptic actuator 122. The lateral haptic feedback can be perceived by the user to simulate mechanical characteristics of a keyboard. In addition, haptic module 126 can send a signal to speaker 134a causing speaker 134a to provide acoustic feedback in response to the touching of the specific key. Also, haptic module 126 can send a signal to an illumination source corresponding to the key that was touched (e.g., illumination source 132a) to provide illuminated feedback in response to the touch of the specific key. The haptic response from haptic actuator 122 can be synced with acoustic and visual (i.e., illumination) feedback to allow for a typing experience that is improved over a touch-screen typing experience.

Turning to FIG. 6, FIG. 6 is a simplified cutaway side view illustrating an embodiment of a portion of an electronic device in accordance with one embodiment of the present disclosure. Second housing 104 can include keyboard 108, key feedback module 120, a plurality of illumination sources 132d and 132e, and a speaker 134b. Keyboard 108 can include a plurality of keys 112a-112c. Key feedback module 120 can include illumination module 128 and sound module 130. In an example, illumination source 132a-132c can correspond to a specific group of keys 112a-112c. In another example, each illumination source 132d and 132e can be a variable illumination source than can vary the color and/or intensity of the illumination output. For example, illumination source 132d may correspond to keys 112a and 112b and can emit a blue light when key 112a is touched or activated and can emit a green light when key 112b is touched or activated. Speaker 134b may be a second housing 104 speaker that is used for system audio functions.

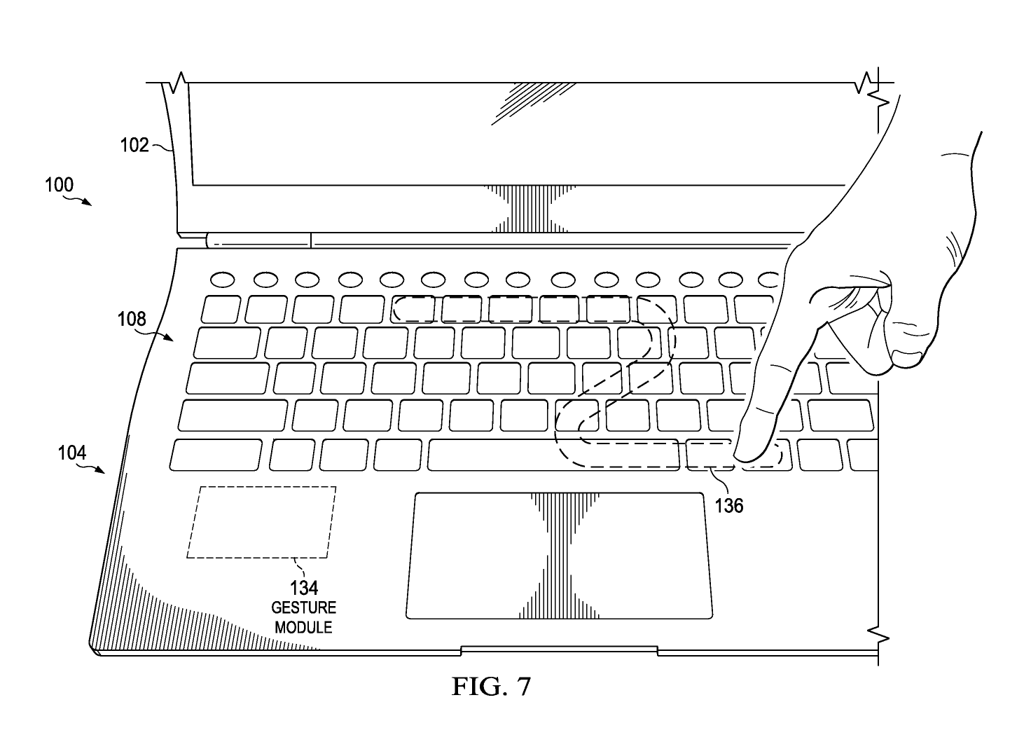

Turning to FIG. 7, FIG. 7 is a simplified pan view illustrating an embodiment of a portion of an electronic device in accordance with one embodiment of the present disclosure. Second housing 104 can include keyboard 108 and gesture module 134. Gesture module 134 can be configured to interpret gesture input 136 on keyboard 108 and initiate a proper response. For example, if electronic device 100 is in a sleep or off mode, a specific gesture input 136 may cause electronic device 100 to wake up or power on.

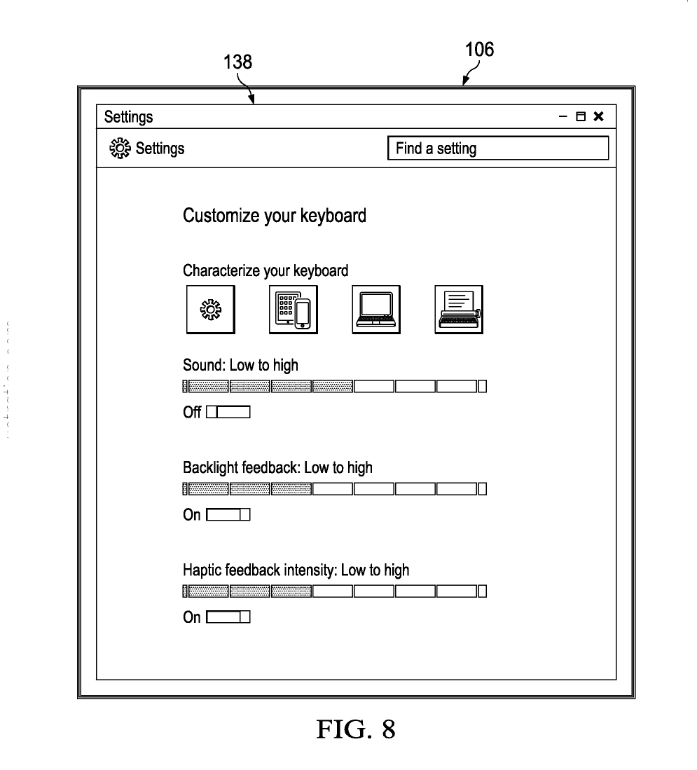

Turning to FIG. 8, FIG. 8 is a simplified block diagram illustrating an embodiment of a portion of an electronic device in accordance with one embodiment of the present disclosure. Display 106 can include a user interface 138. User interface 138 can allow a user to customize the feedback the user experiences when using keyboard 108. For example, if key feedback module 120 includes sound module 130, then the sound made in response to activation of a specific key 118 can be adjusted or turned off. Also, if key feedback module 120 includes illumination module 128, then the intensity of the illumination can be adjusted or turned off. In addition, if key feedback module 120 includes haptic module 126, then the haptic feedback intensity can be adjusted or turned off.

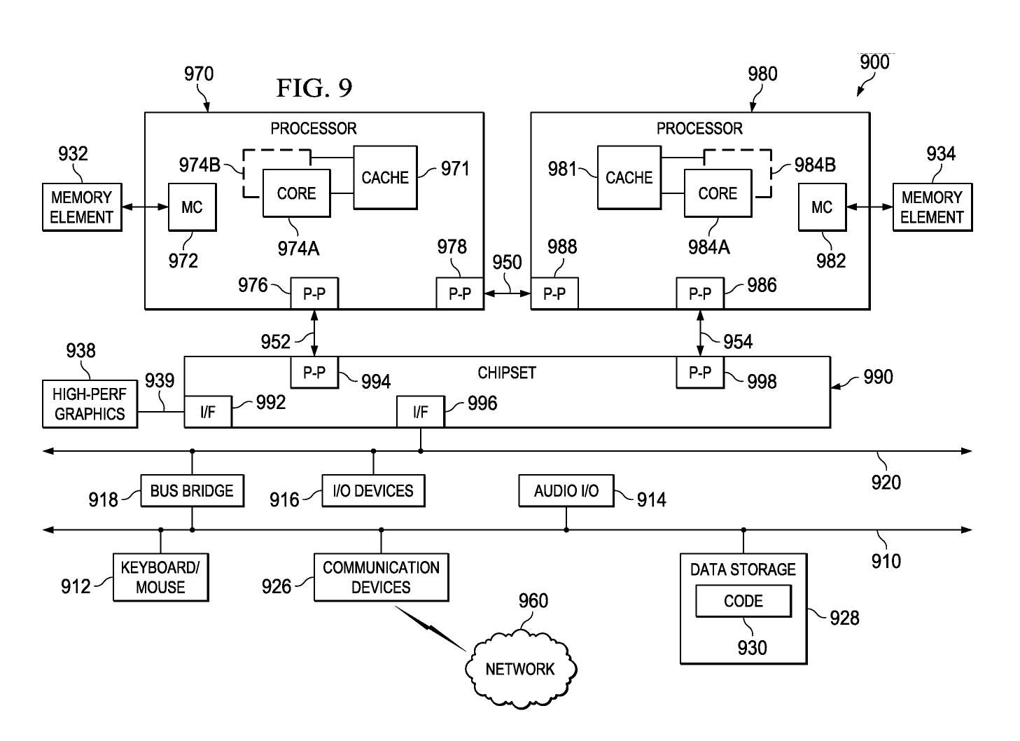

Turning to FIG. 9, FIG. 9 illustrates a computing system 900 that is arranged in a point-to-point (PtP) configuration according to an embodiment. In particular, FIG. 9 shows a system where processors, memory, and input/output devices are interconnected by a number of point-to-point interfaces. Generally, one or more of the network elements of electronic device 100 may be configured in the same or similar manner as computing system 900.

As illustrated in FIG. 9, system 900 may include several processors, of which only two, processors 970 and 980, are shown for clarity. While two processors 970 and 980 are shown, it is to be understood that an embodiment of system 900 may also include only one such processor. Processors 970 and 980 may each include a set of cores (i.e., processor cores 974A and 974B and processor cores 984A and 984B) to execute multiple threads of a program. The cores may be configured to execute instruction code in a manner similar to that discussed above with reference to FIGS. 2-6. Each processor 970, 980 may include at least one shared cache 971, 981. Shared caches 971, 981 may store data (e.g., instructions) that are utilized by one or more components of processors 970, 980, such as processor cores 974 and 984.

Processors 970 and 980 may also each include integrated memory controller logic (MC) 972 and 982 to communicate with memory elements 932 and 934. Memory elements 932 and/or 934 may store various data used by processors 970 and 980. In alternative embodiments, memory controller logic 972 and 982 may be discrete logic separate from processors 970 and 980.

Processors 970 and 980 may be any type of processor, and may exchange data via a point-to-point (PtP) interface 950 using point-to-point interface circuits 978 and 988, respectively. Processors 970 and 980 may each exchange data with a control logic 990 via individual point-to-point interfaces 952 and 954 using point-to-point interface circuits 976, 986, 994, and 998. Control logic 990 may also exchange data with a high-performance graphics circuit 938 via a high-performance graphics interface 939, using an interface circuit 992, which could be a PtP interface circuit. In alternative embodiments, any or all of the PtP links illustrated in FIG. 9 could be implemented as a multi-drop bus rather than a PtP link.

Control logic 990 may be in communication with a bus 920 via an interface circuit 996. Bus 920 may have one or more devices that communicate over it, such as a bus bridge 918 and I/O devices 916. Via a bus 910, bus bridge 918 may be in communication with other devices such as a keyboard/mouse 912 (or other input devices such as a touch screen, trackball, etc.), communication devices 926 (such as modems, network interface devices, or other types of communication devices that may communicate through a computer network 960), audio I/O devices 914, and/or a data storage device 928. Data storage device 928 may store code 930, which may be executed by processors 970 and/or 980. In alternative embodiments, any portions of the bus architectures could be implemented with one or more PtP links.

The computer system depicted in FIG. 9 is a schematic illustration of an embodiment of a computing system that may be utilized to implement various embodiments discussed herein. It will be appreciated that various components of the system depicted in FIG. 9 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

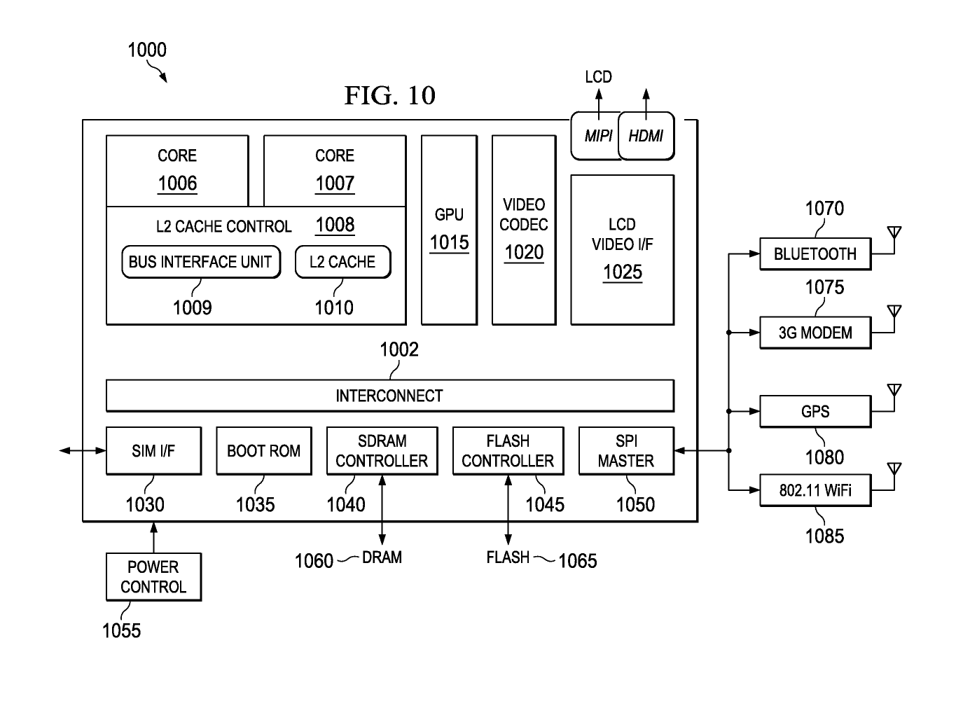

Turning to FIG. 10, FIG. 10 is a simplified block diagram associated with an example ARM ecosystem SOC 1000 of the present disclosure. At least one example implementation of the present disclosure can include the haptic effect features discussed herein and an ARM component. For example, the example of FIG. 10 can be associated with any ARM core (e.g., A-9, A-15, etc.). Further, the architecture can be part of any type of tablet, smartphone (inclusive of Android™ phones, iPhones™, iPad™ Google Nexus™, Microsoft Surface™, personal computer, server, video processing components, laptop computer (inclusive of any type of notebook), Ultrabook™ system, any type of touch-enabled input device, etc.

In this example of FIG. 10, ARM ecosystem SOC 1000 may include multiple cores 1006-1007, an L2 cache control 1008, a bus interface unit 1009, an L2 cache 1010, a graphics processing unit (GPU) 1015, an interconnect 1002, a video codec 1020, and a liquid crystal display (LCD) I/F 1025, which may be associated with mobile industry processor interface (MIPI)/high-definition multimedia interface (HDMI) links that couple to an LCD.

ARM ecosystem SOC 1000 may also include a subscriber identity module (SIM) I/F 1030, a boot read-only memory (ROM) 1035, a synchronous dynamic random access memory (SDRAM) controller 1040, a flash controller 1045, a serial peripheral interface (SPI) master 1050, a suitable power control 1055, a dynamic RAM (DRAM) 1060, and flash 1065. In addition, one or more embodiments include one or more communication capabilities, interfaces, and features such as instances of Bluetooth™ 1070, a 3G modem 1075, a global positioning system (GPS) 1080, and an 802.11 Wi-Fi 1085.

In operation, the example of FIG. 10 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe™ Flash™ Player, Java Platform Standard Edition (Java SE), JavaFX, Linux, Microsoft Windows Embedded, Symbian and Ubuntu, etc.). In at least one embodiment, the core processor may implement an out-of-order superscalar pipeline with a coupled low-latency level-2 cache.

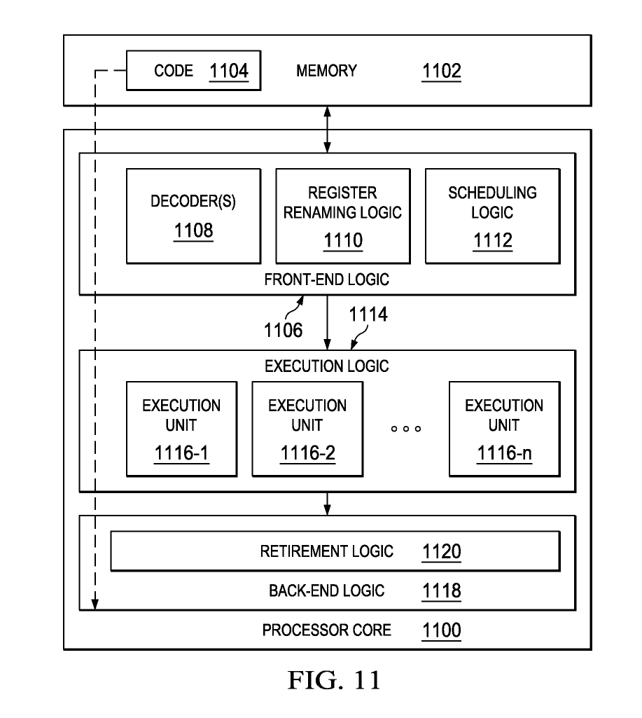

FIG. 11 illustrates a processor core 1100 according to an embodiment. Processor core 11 may be the core for any type of processor, such as a micro-processor, an embedded processor, a digital signal processor (DSP), a network processor, or other device to execute code. Although only one processor core 1100 is illustrated in FIG. 11, a processor may alternatively include more than one of the processor core 1100 illustrated in FIG. 11. For example, processor core 1100 represents an embodiment of processors cores 974a, 974b, 984a, and 984b shown and described with reference to processors 970 and 980 of FIG. 9. Processor core 1100 may be a single-threaded core or, for at least one embodiment, processor core 1100 may be multithreaded in that it may include more than one hardware thread context (or “logical processor”) per core.

FIG. 11 also illustrates a memory 1102 coupled to processor core 1100 in accordance with an embodiment. Memory 1102 may be any of a wide variety of memories (including various layers of memory hierarchy) as are known or otherwise available to those of skill in the art. Memory 1102 may include code 1104, which may be one or more instructions, to be executed by processor core 1100. Processor core 1100 can follow a program sequence of instructions indicated by code 1104. Each instruction enters a front-end logic 1106 and is processed by one or more decoders 1108. The decoder may generate, as its output, a micro operation such as a fixed width micro operation in a predefined format, or may generate other instructions, microinstructions, or control signals that reflect the original code instruction. Front-end logic 1106 also includes register renaming logic 1110 and scheduling logic 1112, which generally allocate resources and queue the operation corresponding to the instruction for execution.

Processor core 1100 can also include execution logic 1114 having a set of execution units 1116-1 through 1116-N. Some embodiments may include a number of execution units dedicated to specific functions or sets of functions. Other embodiments may include only one execution unit or one execution unit that can perform a particular function. Execution logic 1114 performs the operations specified by code instructions.

After completion of execution of the operations specified by the code instructions, back-end logic 1118 can retire the instructions of code 1104. In one embodiment, processor core 1100 allows out of order execution but requires in order retirement of instructions. Retirement logic 1120 may take a variety of known forms (e.g., re-order buffers or the like). In this manner, processor core 1100 is transformed during execution of code 1104, at least in terms of the output generated by the decoder, hardware registers and tables utilized by register renaming logic 1110, and any registers (not shown) modified by execution logic 1114.

Although not illustrated in FIG. 11, a processor may include other elements on a chip with processor core 1100, at least some of which were shown and described herein with reference to FIG. 9. For example, as shown in FIG. 9, a processor may include memory control logic along with processor core 1100. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that electronic device 100 and its teachings are readily scalable and can accommodate a large number of components, as well as more complicated/sophisticated arrangements and configurations. Accordingly, the examples provided should not limit the scope or inhibit the broad teachings of electronic device 100 as potentially applied to a myriad of other architectures.

It is also important to note that the operations in the diagrams illustrate only some of the possible correlating scenarios and patterns that may be executed by, or within, electronic device 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by electronic device 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure.

Moreover, certain components may be combined, separated, eliminated, or added based on particular needs and implementations. Additionally, although electronic device 100 has been illustrated with reference to particular elements and operations that facilitate the communication process, these elements and operations may be replaced by any suitable architecture, protocols, and/or processes that achieve the intended functionality of electronic device 100. As used herein, the term “and/or” is to include an and or an or condition. For example, A, B, and/or C would include A, B, and C; A and B; A and C; B and C; A, B, or C; A or B; A or C; B or C; and any other variations thereof.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

1. An electronic device, comprising:
a plurality of keys, wherein each key is configured as a shallow depression in a surface of the electronic device; and
a key feedback module, wherein the key feedback module can provide lateral haptic feedback to a specific key when the specific key is activated and acoustic feedback when the specific key is activated.

2. (canceled)

3. The keyboard of claim 1, wherein the haptic key feedback module can provide a first visual feedback when the specific key is activated and a second visual feedback when a second specific key is activated, wherein the first visual feedback is different than the second visual feedback.

4. The keyboard of claim 1, wherein the lateral haptic feedback and the acoustic feedback can be adjusted using a user interface.

5. The keyboard of claim 1, wherein an actuator provides the lateral haptic feedback and the lateral haptic feedback can be perceived to simulate mechanical characteristics of a mechanical keyboard.

6. (canceled)

7. The keyboard of claim 1, wherein the electronic device is a peripheral keyboard.

8. An electronic device, comprising:
a first hosing, wherein the first housing includes a display; and
a second housing, wherein the second housing includes a keyboard and the keyboard includes:
a plurality of keys, wherein each key in the plurality of keys is configured as a shallow depression in a surface of the electronic device; and
a key feedback module, wherein the key feedback module can provide lateral haptic feedback to a specific key when the specific key is activated, wherein the key feedback module can provide acoustic feedback when the specific key is activated.

9. (canceled)

10. The electronic device of claim 8, wherein the key feedback module can provide a first visual feedback when the specific key is activated and a second visual feedback when a second specific key is activated, wherein the first visual feedback is different than the second visual feedback.

11. The electronic device of claim 8, wherein the lateral haptic feedback and the acoustic feedback can be adjusted using a user interface.

12. The electronic device of claim 8, wherein an actuator provides the lateral haptic feedback and the lateral haptic feedback can be perceived to simulate mechanical characteristics of a keyboard.

13. (canceled)

14. The electronic device of claim 8, wherein the electronic device is a laptop computer.

15. A method comprising:
receiving a signal from a key indicating that the key has been activated, wherein the key is part a of plurality of keys and each key is configured as a shallow depression in a surface of an electronic device,
sending lateral haptic feedback to the key in response to the received signal that the key was activated; and
sending acoustic feedback in response to the received signal indicating that the key was activated.

16. (canceled)

17. The method of claim 15, further comprising:
sending a signal to generate a first visual feedback in response to the received signal indicating that the key was activated, wherein a second visual feedback is generated when a second key is activated, wherein the first visual feedback is different than the second visual feedback.

18. A system, comprising:
means for receiving a signal from a key, the signal indicating that the key has been activated, wherein the key is part a of plurality of keys and each key is configured as a shallow depression in a surface of an electronic device,
means for sending lateral haptic feedback to the key in response to the received signal that the key was activated; and
means for sending acoustic feedback in response to the received signal indicating that the key was activated.

19. (canceled)

20. The system of claim 18, further comprising:
means for generating a first visual feedback in response to the received signal indicating that the key was activated, wherein a second visual feedback is generated when a second key is activated, wherein the first visual feedback is different than the second visual feedback.

21. The keyboard of claim 1, wherein a center depth of each key in the plurality of keys is greater than a side depth of each key in the plurality of keys to create a slope.

22. The keyboard of claim 3, wherein the lateral haptic feedback, the acoustic feedback, and the first visual feedback can each be adjusted using a user interface.
